(19) United States
(12) Patent Application Publication
(10) Pub. No.: US 2024/0354973 A1
(43) Pub. Date: Oct. 24, 2024

(54) SYSTEMS AND METHODS FOR AUGMENTING IMAGE EMBEDDINGS USING DERIVED GEOMETRIC EMBEDDINGS

(71) Applicant: Toyota Research Institute, Inc., Los Altos, CA (US)

(72) Inventors: Vitor Campagnolo Guizilini, Santa Clara, CA (US); Igor Vasiljevic, San Mateo, CA (US); Dian Chen, San Jose, CA (US); Adrien David Gaidon, San Jose, CA (US); Rares A. Ambrus, San Francisco, CA (US)

(73) Assignees: Toyota Research Institute, Inc., Los Altos, CA (US); Toyota Jidosha Kabushiki Kaisha, Toyota-shi Aichi-ken (JP)

(21) Appl. No.: 18/465,381

(22) Filed: Sep. 12, 2023

Related U.S. Application Data
(60) Provisional application No. 63/461,041, filed on Apr. 21, 2023.

(51) Int. Cl. G06T 7/50; G06T 3/40; G06T 7/60; G06T 15/10

(52) U.S. Cl. CPC G06T 7/50; G06T 3/40; G06T 7/60; G06T 15/10; G06T 2207/20081; G06T 2207/30252

(57) ABSTRACT

Systems, methods, and other embodiments described herein relate to augmenting image embeddings using derived geometries for estimating scaled depth. In one embodiment, a method includes generating a geometric viewing vector using pixel coordinates and intrinsic parameters about a camera for an image captured about a scene. The method also includes deriving geometric embeddings from the geometric viewing vector associated with the image for the camera. The method also includes computing a representation by augmenting image embeddings with the geometric embeddings, the image embeddings associated with visual characteristics about the image. The method also includes estimating a scaled depth of the image from the representation.

### CROSS-REFERENCE TO RELATED APPLICATIONS

This application claims benefit of U.S. Provisional Application No. 63/461,041, filed on, Apr. 21, 2023, which is herein incorporated by reference in its entirety.

### TECHNICAL FIELD

The subject matter described herein relates, in general, to deriving geometric embeddings about a camera, and, more particularly, to augmenting image embeddings using derived geometries for estimating scaled depth.

### BACKGROUND

Vehicles acquire sensor data for perceiving other vehicles, obstacles, pedestrians, and additional aspects of a surrounding environment. For example, a vehicle uses a light detection and ranging (LIDAR) sensor that scans the surrounding environment, while logic associated with the LIDAR analyzes acquired data for detecting objects and other features of the surrounding environment. Similarly, vehicles use cameras to acquire information about the surrounding environment from which a system derives awareness about aspects of the surrounding environment. Vehicles can perceive depth about the surrounding environment using camera data so that systems such as automated driving systems (ADS) can accurately plan and navigate accordingly.

In general, the further awareness is developed by the vehicle about a surrounding environment, the better an operator can be supplemented with information to assist in driving and the better the ADS can control the vehicle around hazards. However, learning models using camera data to estimate depth for the ADS control can demand multiple images and cameras for accuracy, thereby increasing system costs. Furthermore, learning models extracting representations about a scene from an image encounter difficulties from varying camera parameters (e.g., focal length, resolution, etc.) that skew object scales. These representations may include global properties about the scene but lack local significance and actual measures (e.g., a metric scale) demanded by the ADS and other complex tasks, thereby causing scale inaccuracies. Accordingly, vehicles estimating depth using learning models encounter difficulties estimating depth that reduces compatibility with demanding tasks.

### SUMMARY

In one embodiment, example systems and methods relate to augmenting image embeddings using derived geometries for estimating scaled depth. In various implementations, systems that estimate depth maps using multiple images can predict geometries and scale objects within a scene. Other systems using a single camera may demand assistance for predicting object scale and feature positions through manual annotation. However, these systems encounter difficulties scaling objects to real-world measures (e.g., a metric scale) that are transferrable across domains since geometric parameters of different cameras vary. Therefore, in one embodiment, an estimation system augments image embeddings with intrinsic parameters about a camera for scaling objects associated with an image. In one approach, the estimation system generates a geometric viewing vector for pixels of a single image using the intrinsic parameters (e.g., focal length, resolution, etc.). The geometric viewing vector factors how the intrinsic parameters effect the positional properties of a pixel. Furthermore, the estimation system derives geometric embeddings that represent physical properties from a geometric model about the camera using the geometric viewing vector. In this way, processing the image embeddings (e.g., color, brightness, etc.) and the geometric embeddings instead of raw values allows the estimation system to simplify computations, thereby improving system efficiency.

Moreover, the estimation system predicts scale priors (e.g., initial assumptions about data) for the objects having actual measurements from augmenting the image embeddings with the geometric embeddings. In this way, the estimation system can transfer the scale priors to other cameras and image datasets, notwithstanding varying intrinsic parameters since they represent real-world measures. Furthermore, in various implementations, the estimation system encodes the geometric viewing vector by unprojecting the pixels into a three-dimensional (3D) space while factoring the intrinsic parameters for improving representation accuracy of depth. Regarding system outputs, the estimation system estimates a scaled depth having real measures (e.g., a metric scale) instead of absolute values that improves data transferability. Accordingly, the estimation system learns scale priors and depth that are transferrable across various datasets and cameras without increasing computational complexity.

In one embodiment, an estimation system for augmenting image embeddings using derived geometries for estimating scaled depth is disclosed. The estimation system includes a memory storing instructions, that when executed by a processor, cause the processor to generate a geometric viewing vector using pixel coordinates and intrinsic parameters about a camera for an image captured about a scene. The instructions also include instructions to derive geometric embeddings from the geometric viewing vector associated with the image for the camera. The instructions also include instructions to compute a representation by augmenting image embeddings with the geometric embeddings, the image embeddings associated with visual characteristics about the image. The instructions also include instructions to estimate a scaled depth of the image from the representation.

In one embodiment, a non-transitory computer-readable medium for augmenting image embeddings using derived geometries for estimating scaled depth and including instructions that when executed by a processor cause the processor to perform one or more functions is disclosed. The instructions include instructions to generate a geometric viewing vector using pixel coordinates and intrinsic parameters about a camera for an image captured about a scene. The instructions also include instructions to derive geometric embeddings from the geometric viewing vector associated with the image for the camera. The instructions also include instructions to compute a representation by augmenting image embeddings with the geometric embeddings, the image embeddings associated with visual characteristics about the image. The instructions also include instructions to estimate a scaled depth of the image from the representation.

In one embodiment, a method for augmenting image embeddings using derived geometries for estimating scaled depth is disclosed. In one embodiment, the method includes generating a geometric viewing vector using pixel coordinates and intrinsic parameters about a camera for an image captured about a scene. The method also includes deriving geometric embeddings from the geometric viewing vector associated with the image for the camera. The method also includes computing a representation by augmenting image embeddings with the geometric embeddings, the image embeddings associated with visual characteristics about the image. The method also includes estimating a scaled depth of the image from the representation.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of an estimation system that is associated with augmenting image embeddings using derived geometries for estimating scaled depth.

FIG. 3 illustrates one embodiment of the estimation system deriving geometric embeddings about a camera using a viewing vector from an image.

FIG. 4 illustrates one embodiment of a method that is associated with augmenting image embeddings using geometric embeddings and estimating scaled depth from a representation about a scene.

FIG. 5 illustrates an example of a vehicle implementing the estimation system on a road for predicting scaled depth using geometric embeddings.

### DETAILED DESCRIPTION

Systems, methods, and other embodiments associated with augmenting image embeddings using derived geometries for estimating scaled depth are disclosed herein. In various implementations, systems estimating depth from an image in a metric rather than an arbitrary scale are demanded for accurately executing complex tasks (e.g., path planning, automated driving, etc.). Systems can process views from the multiple cameras for scaling objects within a scene on metric measurements (e.g., meters, centimeters, etc.). However, these systems are costlier than single-camera systems and consume substantial computing resources for estimating scale from processing multiple images. Furthermore, certain systems encounter scale inconsistencies when transferring depth estimates about unforeseen objects from varying geometric parameters of cameras. For example, geometric parameters such as focal lengths, resolution, and so on lead to inaccurate scale factors. Accordingly, object estimates can have inconsistent physical shapes when projecting points to 3D.

Therefore, in one embodiment, an estimation system generates positional embeddings about a camera for learning a scale prior (e.g., initial assumptions about data) and depth about objects that are readily transferrable. Positional embeddings can incorporate parameters such as pose associated with a camera as a system input. As such, systems can generate unique views from arbitrary viewpoints with the positional embeddings. In one approach, the estimation system injects an image with intrinsic parameters representing camera geometry by inputting geometric embeddings similar to positional embeddings. The estimation system may derive the geometric embeddings representing physical properties from a geometric model about the camera using a geometric viewing vector. Here, the geometric viewing vector captures the influence of geometric parameters on various pixels. As such, the estimation system augments image embeddings (e.g., color, brightness, etc.) reflecting visual characteristics about the image with the geometric embeddings. In this way, a learning model can estimate object shapes and a scale prior for the image independent of the intrinsic parameters. Furthermore, the scale prior has geometric meaning regardless of intrinsic parameters (e.g., resolution) about the camera, thereby allowing transferability across datasets and cameras that improves system compatibility.

Moreover, in one embodiment, the estimation system encodes the geometric viewing vector using Fourier encoding notwithstanding object properties within a scene (e.g., pose). Here, the Fourier encoding may factor a center of the camera and the geometric embeddings factor frequency bands identified through the Fourier encoding. Furthermore, the estimation system can scale the intrinsic parameters to image resolution for matching the image embeddings, thereby incorporating a relationship between the camera geometry and visual properties. In this way, the estimation system decouples object properties from the intrinsic parameters for estimating depth from a single image. Accordingly, the estimation system learns scale priors that are transferrable by injecting derived geometric embeddings to image data that improve system robustness without increasing complexity.

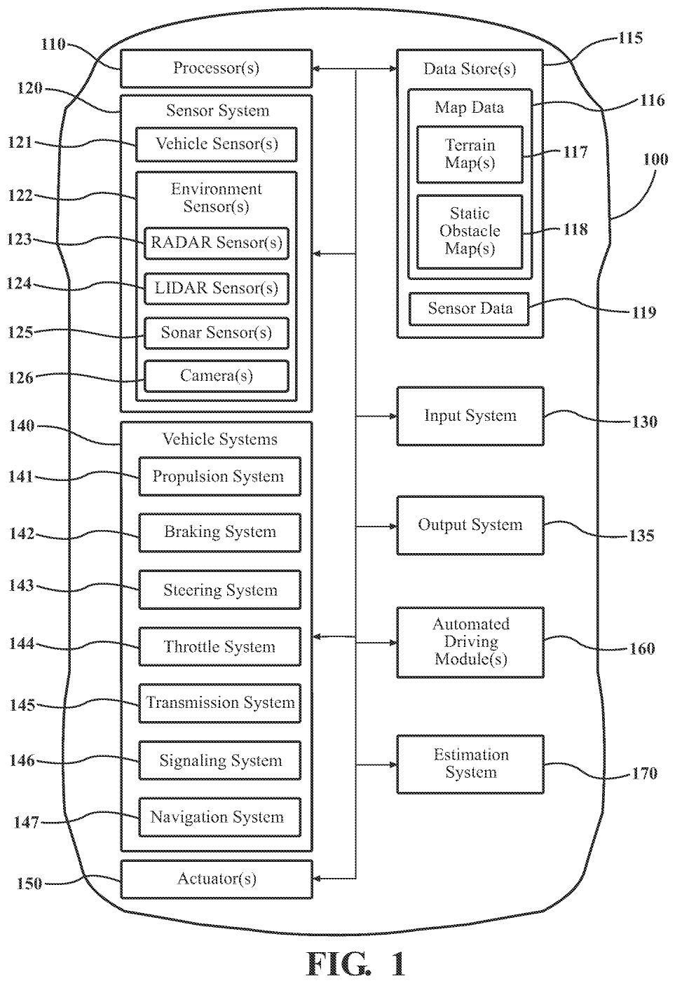

Referring to FIG. 1, an example of a vehicle 100 is illustrated. As used herein, a “vehicle” is any form of motorized transport. In one or more implementations, the vehicle 100 is an automobile. While arrangements will be described herein with respect to automobiles, it will be understood that embodiments are not limited to automobiles. In some implementations, an estimation system 170 uses road-side units (RSU), consumer electronics (CE), mobile devices, robots, drones, and so on that benefit from the functionality discussed herein associated with augmenting image embeddings using derived geometries for estimating scaled depth.

The vehicle 100 also includes various elements. It will be understood that in various embodiments, the vehicle 100 may have less than the elements shown in FIG. 1. The vehicle 100 can have any combination of the various elements shown in FIG. 1. Furthermore, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Furthermore, the elements shown may be physically separated by large distances. For example, as discussed, one or more components of the disclosed system can be implemented within a vehicle while further components of the system are implemented within a cloud-computing environment or other system that is remote from the vehicle 100.

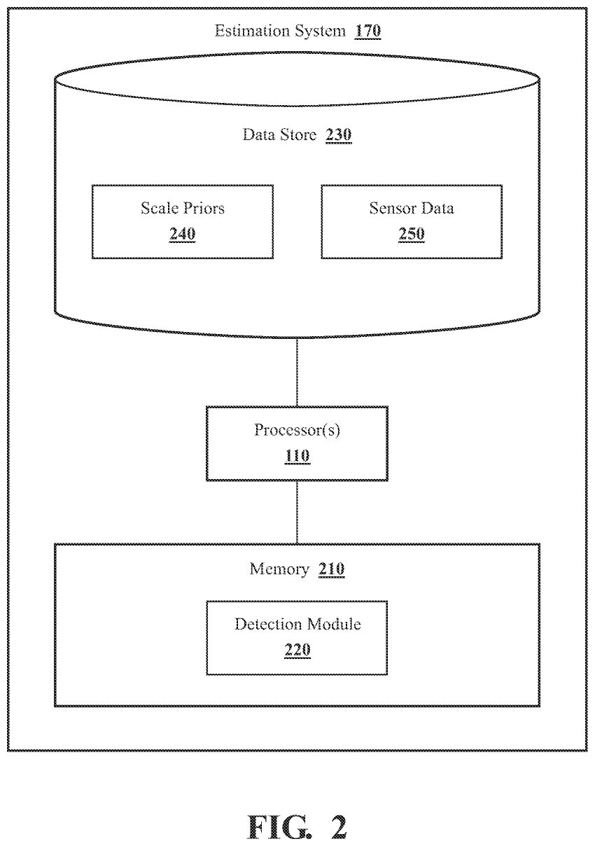

Some of the possible elements of the vehicle 100 are shown in FIG. 1 and will be described along with subsequent figures. However, a description of many of the elements in FIG. 1 will be provided after the discussion of FIGS. 2-5 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, the vehicle 100 includes an estimation system 170 that is implemented to perform methods and other functions as disclosed herein relating to improving augmenting image embeddings using derived geometries for estimating scaled depth.

With reference to FIG. 2, one embodiment of the estimation system 170 of FIG. 1 is further illustrated. The estimation system 170 is shown as including a processor(s) 110 from the vehicle 100 of FIG. 1. Accordingly, the processor(s) 110 may be a part of the estimation system 170, the estimation system 170 may include a separate processor from the processor(s) 110 of the vehicle 100, or the estimation system 170 may access the processor(s) 110 through a data bus or another communication path. In one embodiment, the estimation system 170 includes a memory 210 that stores a detection module 220. The memory 210 is a random-access memory (RAM), a read-only memory (ROM), a hard-disk drive, a flash memory, or other suitable memory for storing the detection module 220. The detection module 220 is, for example, computer-readable instructions that when executed by the processor(s) 110 cause the processor(s) 110 to perform the various functions disclosed herein.

With reference to FIG. 2, the detection module 220 generally includes instructions that function to control the processor(s) 110 to receive data inputs from one or more sensors of the vehicle 100. The inputs are, in one embodiment, observations of one or more objects in an environment proximate to the vehicle 100 and/or other aspects about the surroundings. As provided for herein, the detection module 220, in one embodiment, acquires the sensor data 250 that includes at least camera images. In further arrangements, the detection module 220 acquires the sensor data 250 from further sensors such as radar sensors 123, LIDAR sensors 124, and other sensors as may be suitable for identifying vehicles and locations of the vehicles.

Accordingly, the detection module 220, in one embodiment, controls the respective sensors to provide the data inputs in the form of the sensor data 250. Additionally, while the detection module 220 is discussed as controlling the various sensors to provide the sensor data 250, in one or more embodiments, the detection module 220 can employ other techniques to acquire the sensor data 250 that are either active or passive. For example, the detection module 220 may passively sniff the sensor data 250 from a stream of electronic information provided by the various sensors to further components within the vehicle 100. Moreover, the detection module 220 can undertake various approaches to fuse data from multiple sensors when providing the sensor data 250 and/or from sensor data acquired over a wireless communication link.

In various embodiments, the estimation system 170 includes a data store 230. In one embodiment, the data store 230 is a database. The database is, in one embodiment, an electronic data structure stored in the memory 210 or another data store and that is configured with routines that can be executed by the processor(s) 110 for analyzing stored data, providing stored data, organizing stored data, and so on. Thus, in one embodiment, the data store 230 stores data used by the detection module 220 in executing various functions. In one embodiment, the data store 230 includes the sensor data 250 along with, for example, metadata that characterize various aspects of the sensor data 250. For example, the metadata can include location coordinates (e.g., longitude and latitude), relative map coordinates or tile identifiers, time/date stamps from when the separate sensor data 250 was generated, and so on. In one embodiment, the data store 230 further includes the scale priors 240. Here, the scale priors 240 can be an initial assumption or constraint about object scale imposed by a model. In one approach, the scale priors 240 are derived from the resolution, focal length, and so on associated with a captured image.

Moreover, a learning model can accurately predict feature positions about objects within a scene using the scale priors 240 from the estimation system 170, notwithstanding being unknown during training. In other words, the learning model can accurately predict depth maps using the scale priors 240 transferred even though training involved known priors representing appearance characteristics about the objects without depth information, thereby allowing a zero-shot transfer. As explained below, the estimation system 170 augmenting image embeddings (e.g., color, brightness, etc.) with geometric embeddings allows zero-shot learning through deriving scale priors for feature predictions about data samples and objects absent during training. In this way, the estimation system 170 can transfer the scale priors for accurate depth estimates to a vehicle having a sensor with atypical geometric properties, thereby improving system robustness.

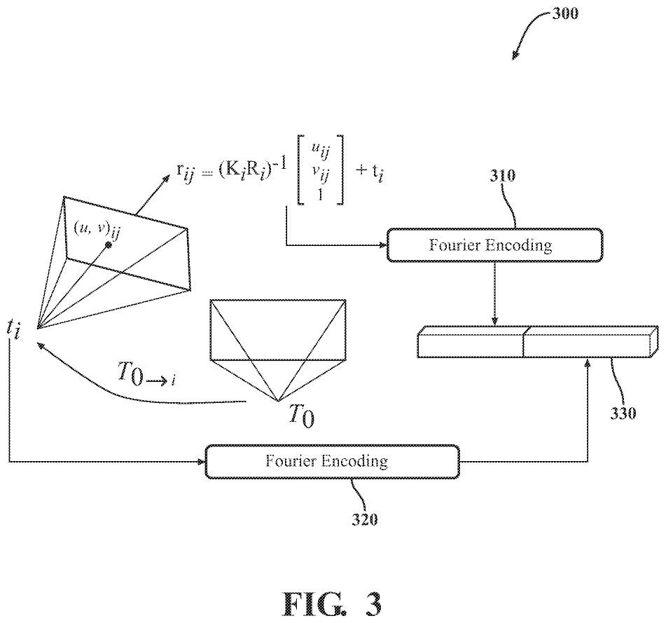

Turning now to FIG. 3, one embodiment of the estimation system 170 deriving geometric embeddings about a camera using a viewing vector for an image is illustrated. Similar to positional embeddings, the estimation system 170 using the geometric embeddings as a system input can generate outputs of positional information from arbitrary viewpoints. As such, downstream systems can reliably estimate 3D depth rather than extract features using the positional information. In these respects, the detection module 220 includes instructions that cause the processors 110 to generate a geometric viewing vector using pixel coordinates and intrinsic parameters about a camera. In one approach, the geometric viewing vector is generated for every pixel vector by unprojecting pixel coordinates into a 3D space using intrinsic parameters about a camera. For instance, the intrinsic parameters are one of a focal length, an aperture, an orientation, a field-of-view, a resolution, and so on parameter represented by the intrinsics matrix Kₜ. As such, the geometric viewing vector of a pixel pᵢⱼ=[uᵢⱼ, vᵢⱼ] may be expressed as:

rₜ^{ij}=Kₜ⁻¹[uᵢⱼ,vᵢⱼ,1]^{T}+tᵢ, Equation (1)

In Equation (1), t represents the translation vector for camera index i having coordinates (x, y, z), where tₜ is the camera center. Kₜ can be expressed as KᵢRᵢ. For example, Rᵢ is a 3×3 rotation matrix of the camera defining a viewing direction. R, in conjunction with the 3×3 intrinsics matrix Kᵢ allow projecting a viewing ray in 3D space per pixel. Furthermore, the origin camera may be represented by i=0 having a transformation matrix T₀ (e.g., 4×4) and variables (i, j) are the pixel index (e.g., (0, 0) is the top left pixel). However, the pixel coordinates in the image are represented by (u, v).

Regarding computation details, the estimation system 170 encodes the geometric viewing vector using a Fourier encoding 310, notwithstanding pose associated with objects or a scene within an image. Here, the Fourier encoding 310 factors tᵢ and dimensions of the geometric embeddings using frequency components identified from Fourier analysis. In the model 300, the camera center tᵢ and poses are excluded when processing single frames of images (e.g., single-camera systems). In this configuration, the model 300 may assume that every sample for the image embeddings is at the origin of relative coordinates. In other words, the camera is considered to be in the center of the coordinate frame and pointing forward. In one approach, the model 300 processes the camera center tᵢ using 6(Kₒ+1) where 6 represents Fourier analysis (e.g., Fourier transform) along a 3D axis as: (cos x, sin x, cos y, sin y, cos z, sin z). For example, Kₒ is the number of frequencies used to Fourier-encode the origin coordinates when tᵢ is non-zero and the camera has an offset. On the other hand, Kᵣ is the number of frequencies used to Fourier-encode the coordinates for ray r.

Moreover, the estimation system 170 normalizes the vector rₜ^{ij} to produce pixel-level 3(F+1)-dimensional geometric embeddings ε_{G}. Here, F is the number of frequency bands. In this way, instead of raw values, the geometric embeddings ε_{G} incorporate properties about a geometric model representing the camera for simplifying computations. For example, the properties are focal length, aperture, orientation, field-of-view, resolution, and so on. Upon normalization, the estimation system 170 computes a representation by augmenting image embeddings with the geometric embeddings. The image embeddings can be extracted features from raw values of visual characteristics about the image. Accordingly, the estimation system 170 increases computational efficiency since the image embeddings can have a reduced size than the raw values.

Regarding an output of the estimation system 170, the geometric embeddings 330 is formed by the Fourier encoding 310 factoring a camera center tᵢ for zero or non-zero scenarios (e.g., multi-camera systems). When tᵢ is non-zero and multiple cameras generate the sensor data 250 for a scene, the Fourier encoding 310 factors and incorporates spatial effects from multiple images of the scene into the geometric embeddings 330. This component is combined with the Fourier encoding 320 where the model 300 assumes that every sample for the image embeddings is at the origin of relative coordinates. Accordingly, the estimation system 170 generates geometric embeddings for various camera systems, thereby improving robustness.

In various implementations, the estimation system 170 implements geometric embeddings for learning over the physical shape of objects. The estimation system 170 can compute a representation by augmenting image embeddings with the geometric embeddings 330 for estimating a scaled depth of an original image. In this way, the representation is transferable across datasets and cameras having different intrinsic parameters through factoring positional embeddings about the camera. As previously explained, the positional embeddings can incorporate parameters such as pose associated with the camera as a system input and generate unique views from arbitrary viewpoints that improves depth estimation.

Furthermore, in one approach, the parameters are scaled down during encoding to one fourth of an original resolution from an image for matching the image embeddings. During decoding, the estimation system 170 can utilize the original resolution by relying on information from the geometric embeddings. Accordingly, the estimation system 170 accurately learns the physical shape and transferrable scale about objects by augmenting image embeddings with geometric embeddings.

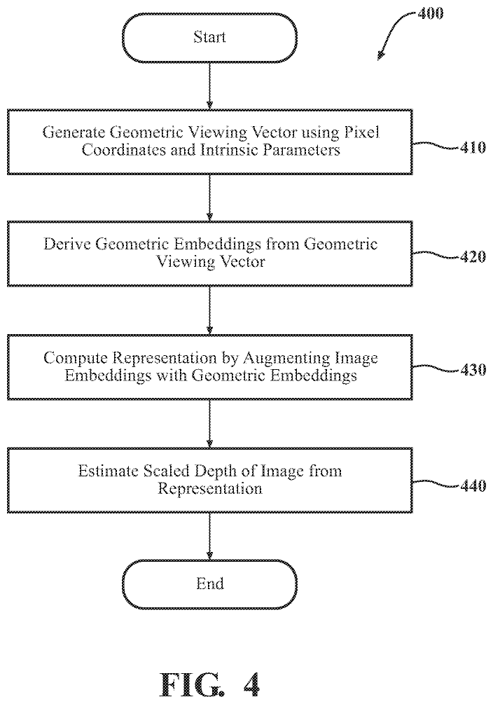

Turning now to FIG. 4, a flowchart of a method 400 that is associated with augmenting image embeddings using geometric embeddings and estimating scaled depth from a representation about a scene is illustrated. Method 400 will be discussed from the perspective of the estimation system 170 of FIGS. 1 and 2. While the method 400 is discussed in combination with the estimation system 170, it should be appreciated that the method 400 is not limited to being implemented within the estimation system 170 but is instead one example of a system that may implement the method 400.

At 410, the estimation system 170 generates a geometric viewing vector using pixel coordinates and intrinsic parameters. In one approach, the geometric viewing vector is generated for pixel vectors by unprojecting pixel coordinates into a 3D space using intrinsic parameters about a camera. As previously explained, the intrinsic parameters may be one of a focal length, an aperture, an orientation, a field-of-view, a resolution, and so on parameter. Here, the pixel coordinates in an image may be translated as pre-processing for improving the Fourier encoding. Furthermore, the intrinsic parameters can be represented by the intrinsics matrix Kₜ for the Fourier encoding. The estimation system 170 generates the geometric embeddings about the image (e.g., a single image, a single frame, etc.) from a camera using the results from the Fourier encoding factoring the intrinsics matrix.

At 420, the estimation system 170 derives geometric embeddings from the geometric viewing vector. In one approach, the estimation system 170 encodes the geometric viewing vector using Fourier encoding that disregards pose associated with a scene for the image. As previously explained, the Fourier encoding factors camera center and dimensions of the geometric embeddings using frequency components identified from Fourier analysis. For example, the camera center is positioned at zero or non-zero (e.g., multi-camera systems) depending on system configurations. For positioning at zero, the estimation system 170 assumes that data samples from a single camera for the image embeddings (e.g., color, brightness, etc.) are at the origin of relative coordinates. Therefore, the camera may be in the center of the coordinate frame and pointing forward for single camera systems.

For non-zero scenarios, multiple cameras generate sensor data for a scene. As such, the Fourier encoding factors and incorporates spatial effects from multiple images of the scene into the geometric embeddings. This component is combined with the Fourier encoding where the model assumes that every sample for the image embeddings is at the origin of relative coordinates. Accordingly, the estimation system 170 generates geometric embeddings for various system configurations and applications, thereby improving robustness.

At 430, the estimation system 170 computes a representation by augmenting image embeddings with the geometric embeddings. Here, the estimation system 170 extracts features from raw values of the image so that the image embeddings have visual characteristics having a reduced form, thereby improving computational efficiency. As previously explained, positional embeddings can incorporate parameters (e.g., pose) associated with cameras as a system input and generate unique views from arbitrary viewpoints and angles. As such, the estimation system 170 factors the positional embeddings about the camera that allows transferability of the representation across datasets and cameras having different intrinsic parameters. Furthermore, augmenting image embeddings with geometric embeddings allows zero-shot learning and deriving real rather than absolute scale priors (e.g., initial assumptions) about objects absent during training. In this way, the estimation system 170 can transfer the scale priors for accurate depth estimates to a vehicle having a sensor with atypical geometric properties, thereby exhibiting system robustness.

At 440, the estimation system 170 and the detection module 220 predict scaled depth of the image from the representation. Here, the scaled depth may be in real-world measures (e.g., a metric scale) that has meaning across domains regardless of cameras having different geometric parameters. In this way, the vehicle 100 executing downstream stream tasks (e.g., automated driving) has reliable and actual scaled depth about a driving environment, thereby improving safety. Accordingly, the estimation system 170 learns scaled depth that is transferable for various datasets and cameras without increasing computing complexity.

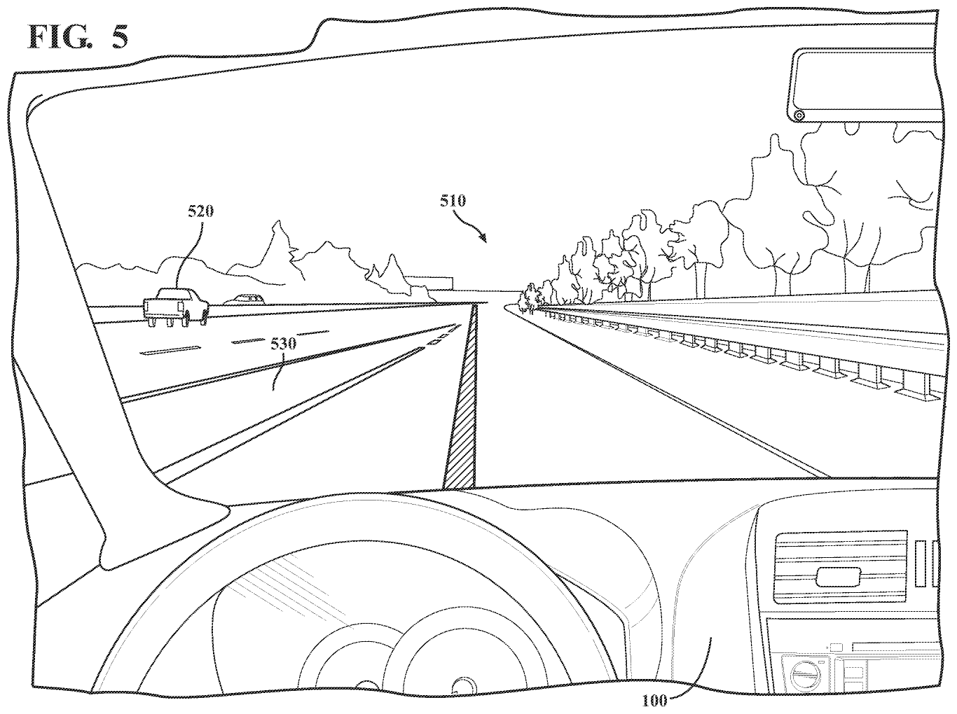

Now turning to FIG. 5, an example of the vehicle 100 implementing the estimation system 170 on a road for predicting scaled depth using geometric embeddings is illustrated. In one approach, the vehicle 100 encodes data using the estimation system 170 about the driving scene 510 having the truck 520. The vehicle 100 predicts scaled depth about road obstacles on the lane 530 for path planning by the automated driving module 160. In one approach, the estimation system 170 derives geometric embeddings from the geometric viewing vector for an image captured by a single camera. Furthermore, the estimation system 170 can compute a representation by augmenting image embeddings with geometric embeddings. Here, the estimation system 170 extracts features from raw values of the image about visual characteristics of the road obstacles having a reduced form, thereby improving computational efficiency. As previously explained, positional embeddings can incorporate parameters (e.g., pose) associated with cameras. As such, the estimation system 170 can generate unique views from arbitrary viewpoints and angles by processing positional embeddings rather than raw values. Accordingly, the automated driving module 160 of the vehicle 100 plans a path on the lane 530 with increased accuracy and precision using scaled depth about road obstacles, thereby improving safety and system performance.

FIG. 1 will now be discussed in full detail as an example environment within which the system and methods disclosed herein may operate. In some instances, the vehicle 100 is configured to switch selectively between different modes of operation/control according to the direction of one or more modules/systems of the vehicle 100. In one approach, the modes include: 0, no automation; 1, driver assistance; 2, partial automation; 3, conditional automation; 4, high automation; and 5, full automation. In one or more arrangements, the vehicle 100 can be configured to operate in a subset of possible modes.

In one or more embodiments, the vehicle 100 is an automated or autonomous vehicle. As used herein, “autonomous vehicle” refers to a vehicle that is capable of operating in an autonomous mode (e.g., category 5, full automation). “Automated mode” or “autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU), an application-specific integrated circuit (ASIC), a microprocessor, etc. The vehicle 100 can include one or more data stores 115 for storing one or more types of data. The data store(s) 115 can include volatile and/or non-volatile memory. Examples of suitable data stores 115 include RAM, flash memory, ROM, programmable read-only memory (PROM), erasable programmable read-only memory (EPROM), electrically erasable programmable read-only memory (EEPROM), registers, magnetic disks, optical disks, and hard drives. The data store(s) 115 can be a component of the processor(s) 110, or the data store(s) 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry.

In one or more arrangements, the map data 116 can include one or more terrain maps 117. The terrain map(s) 117 can include information about the terrain, roads, surfaces, and/or other features of one or more geographic areas. The terrain map(s) 117 can include elevation data in the one or more geographic areas. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles can include trees, buildings, curbs, fences, railings, medians, utility poles, statues, monuments, signs, benches, furniture, mailboxes, large rocks, or hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

One or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information about one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means a device that can detect, and/or sense something. In at least one embodiment, the one or more sensors detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors may function independently or two or more of the sensors may function in combination. The sensor system 120 and/or the one or more sensors can be operatively connected to the processor(s) 110, the data store(s) 115, and/or another element of the vehicle 100. The sensor system 120 can produce observations about a portion of the environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect information about the vehicle 100 itself. In one or more arrangements, the vehicle sensor(s) 121 can be configured to detect position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect one or more characteristics of the vehicle 100 and/or a manner in which the vehicle 100 is operating. In one or more arrangements, the vehicle sensor(s) 121 can include a speedometer to determine a current speed of the vehicle 100.

Alternatively, or in addition, the sensor system 120 can include one or more environment sensors 122 configured to acquire data about an environment surrounding the vehicle 100 in which the vehicle 100 is operating. “Surrounding environment data” includes data about the external environment in which the vehicle is located or one or more portions thereof. For example, the one or more environment sensors 122 can be configured to sense obstacles in at least a portion of the external environment of the vehicle 100 and/or data about such obstacles. Such obstacles may be stationary objects and/or dynamic objects. The one or more environment sensors 122 can be configured to detect other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more of: radar sensors 123, LIDAR sensors 124, sonar sensors 125, weather sensors, haptic sensors, locational sensors, and/or one or more cameras 126. In one or more arrangements, the one or more cameras 126 can be high dynamic range (HDR) cameras, stereo, or infrared (IR) cameras.

The vehicle 100 can include an input system 130. An “input system” includes components or arrangement or groups thereof that enable various entities to enter data into a machine. The input system 130 can receive an input from a vehicle occupant. The vehicle 100 can include an output system 135. An “output system” includes one or more components that facilitate presenting data to a vehicle occupant.

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, any of the systems or portions thereof may be otherwise combined or segregated via hardware and/or software within the vehicle 100. The vehicle 100 can include a propulsion system 141, a braking system 142, a steering system 143, a throttle system 144, a transmission system 145, a signaling system 146, and/or a navigation system 147. Any of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the estimation system 170, and/or the automated driving module(s) 160 can be operatively connected to communicate with the various vehicle systems 140 and/or individual components thereof. For example, the processor(s) 110 and/or the automated driving module(s) 160 can be in communication to send and/or receive information from the various vehicle systems 140 to control the movement of the vehicle 100. The processor(s) 110, the estimation system 170, and/or the automated driving module(s) 160 may control some or all of the vehicle systems 140 and, thus, may be partially or fully autonomous as defined by the society of automotive engineers (SAE) levels 0 to 5.

The processor(s) 110, the estimation system 170, and/or the automated driving module(s) 160 can be operatively connected to communicate with the various vehicle systems 140 and/or individual components thereof. For example, the processor(s) 110, the estimation system 170, and/or the automated driving module(s) 160 can be in communication to send and/or receive information from the various vehicle systems 140 to control the movement of the vehicle 100. The processor(s) 110, the estimation system 170, and/or the automated driving module(s) 160 may control some or all of the vehicle systems 140.

The processor(s) 110, the estimation system 170, and/or the automated driving module(s) 160 may be operable to control the navigation and maneuvering of the vehicle 100 by controlling one or more of the vehicle systems 140 and/or components thereof. For instance, when operating in an autonomous mode, the processor(s) 110, the estimation system 170, and/or the automated driving module(s) 160 can control the direction and/or speed of the vehicle 100. The processor(s) 110, the estimation system 170, and/or the automated driving module(s) 160 can cause the vehicle 100 to accelerate, decelerate, and/or change direction. As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be an element or a combination of elements operable to alter one or more of the vehicle systems 140 or components thereof responsive to receiving signals or other inputs from the processor(s) 110 and/or the automated driving module(s) 160. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor(s) 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processors 110. Alternatively, or in addition, one or more data stores 115 may contain such instructions.

In one or more arrangements, one or more of the modules described herein can include artificial intelligence elements, e.g., neural network, fuzzy logic, or other machine learning algorithms. Furthermore, in one or more arrangements, one or more of the modules can be distributed among a plurality of the modules described herein. In one or more arrangements, two or more of the modules described herein can be combined into a single module.

The vehicle 100 can include one or more automated driving modules 160. The automated driving module(s) 160 can be configured to receive data from the sensor system 120 and/or any other type of system capable of capturing information relating to the vehicle 100 and/or the external environment of the vehicle 100. In one or more arrangements, the automated driving module(s) 160 can use such data to generate one or more driving scene models. The automated driving module(s) 160 can determine position and velocity of the vehicle 100. The automated driving module(s) 160 can determine the location of obstacles, obstacles, or other environmental features including traffic signs, trees, shrubs, neighboring vehicles, pedestrians, etc.

The automated driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module(s) 160 either independently or in combination with the estimation system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data 250. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module(s) 160 can be configured to implement determined driving maneuvers. The automated driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-5 but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein.

The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk™, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. An estimation system comprising:
a memory storing instructions that, when executed by a processor, cause the processor to:
generate a geometric viewing vector using pixel coordinates and intrinsic parameters about a camera for an image captured about a scene;
derive geometric embeddings from the geometric viewing vector associated with the image for the camera;
compute a representation by augmenting image embeddings with the geometric embeddings, the image embeddings associated with visual characteristics about the image; and
estimate a scaled depth of the image from the representation.

2. The estimation system of claim 1, wherein the instructions to derive the geometric embeddings further include instructions to:
normalize the geometric viewing vector by unprojecting the pixel coordinates into a three-dimensional (3D) space for a pixel and factoring the intrinsic parameters; and
encode the geometric viewing vector using Fourier encoding independent of pose associated with the scene and the Fourier encoding factors a center of the camera, and dimensions of the geometric embeddings factor frequency bands identified by the Fourier encoding.

3. The estimation system of claim 2, wherein the instructions to encode the geometric viewing vector further include instructions to:
scale the intrinsic parameters according to a resolution of the image for matching the image embeddings, and the image is a single image; and
decode by a learning model using the resolution and the geometric embeddings that represent physical properties from a geometric model about the camera.

4. The estimation system of claim 2 further including instructions to:
predict by a learning model feature positions about objects within the scene using scale priors derived from the geometric viewing vector, and the scale priors were unknown during training of the learning model that processed known priors representing appearance characteristics about the objects without depth information.

5. The estimation system of claim 4 further including instructions to:
transfer the scale priors to a vehicle having a sensor that acquires an image dataset, wherein the sensor has geometric properties that differ from the intrinsic parameters.

6. The estimation system of claim 2, wherein the instructions to derive the geometric embeddings further include instructions to:
encode the geometric viewing vector using Fourier encoding such that an origin of a coordinate system for the camera is a reference point for the image embeddings.

7. The estimation system of claim 2, wherein the center of the camera is excluded for a frame of the image.

8. The estimation system of claim 1, wherein the intrinsic parameters are one of a focal length, an aperture, an orientation, a field-of-view, and a resolution.

9. A non-transitory computer-readable medium comprising:
instructions that when executed by a processor cause the processor to:
generate a geometric viewing vector using pixel coordinates and intrinsic parameters about a camera for an image captured about a scene;
derive geometric embeddings from the geometric viewing vector associated with the image for the camera;
compute a representation by augmenting image embeddings with the geometric embeddings, the image embeddings associated with visual characteristics about the image; and
estimate a scaled depth of the image from the representation.

10. The non-transitory computer-readable medium of claim 9, wherein the instructions to derive the geometric embeddings further include instructions to:
normalize the geometric viewing vector by unprojecting the pixel coordinates into a three-dimensional (3D) space for a pixel and factoring the intrinsic parameters; and
encode the geometric viewing vector using Fourier encoding independent of pose associated with the scene and the Fourier encoding factors a center of the camera, and dimensions of the geometric embeddings factor frequency bands identified by the Fourier encoding.

11. The non-transitory computer-readable medium of claim 10, wherein the instructions to encode the geometric viewing vector further include instructions to:
scale the intrinsic parameters according to a resolution of the image for matching the image embeddings, and the image is a single image; and
decode by a learning model using the resolution and the geometric embeddings that represent physical properties from a geometric model about the camera.

12. The non-transitory computer-readable medium of claim 10 further including instructions to:
predict by a learning model feature positions about objects within the scene using scale priors derived from the geometric viewing vector, and the scale priors were unknown during training of the learning model that processed known priors representing appearance characteristics about the objects without depth information.

13. A method comprising:
generating a geometric viewing vector using pixel coordinates and intrinsic parameters about a camera for an image captured about a scene;
deriving geometric embeddings from the geometric viewing vector associated with the image for the camera;
computing a representation by augmenting image embeddings with the geometric embeddings, the image embeddings associated with visual characteristics about the image; and
estimating a scaled depth of the image from the representation.

14. The method of claim 13, wherein deriving the geometric embeddings further includes:
normalizing the geometric viewing vector by unprojecting the pixel coordinates into a three-dimensional (3D) space for a pixel and factoring the intrinsic parameters; and
encoding the geometric viewing vector using Fourier encoding independent of pose associated with the scene and the Fourier encoding factors a center of the camera, and dimensions of the geometric embeddings factor frequency bands identified by the Fourier encoding.

15. The method of claim 14, wherein encoding the geometric viewing vector further includes:
scaling the intrinsic parameters according to a resolution of the image for matching the image embeddings, and the image is a single image; and
decoding by a learning model using the resolution and the geometric embeddings that represent physical properties from a geometric model about the camera.

16. The method of claim 14 further comprising:
predicting by a learning model feature positions about objects within the scene using scale priors derived from the geometric viewing vector, and the scale priors were unknown during training of the learning model that processed known priors representing appearance characteristics about the objects without depth information.

17. The method of claim 16 further comprising:
transferring the scale priors to a vehicle having a sensor that acquires an image dataset, wherein the sensor has geometric properties that differ from the intrinsic parameters.

18. The method of claim 14, wherein deriving the geometric embeddings further includes:
encoding the geometric viewing vector using Fourier encoding such that an origin of a coordinate system for the camera is a reference point for the image embeddings.

19. The method of claim 14, wherein the center of the camera is excluded for a frame of the image.

20. The method of claim 13, wherein the intrinsic parameters are one of a focal length, an aperture, an orientation, a field-of-view, and a resolution.
